(19) United States
(12) Patent Application Publication
(10) Pub. No.: US 2002/0036408 A1
(43) Pub. Date: Mar. 28, 2002

(54) Automotive door having burglarproof structure

(76) Inventor: Sam-Seok Jang, Ulsan (KR)

Correspondence Address: CHRISTIE, PARKER & HALE, LLP, P.O. Box 7068, Pasadena, CA, 91109-7068, US

(21) Appl. No.: 09/753,250

(22) Filed: Dec. 27, 2000

(30) Foreign Application Priority Data
Aug. 23, 2000 (KR) 2000-48942

(51) Int. Cl. E05B 3/00

(52) U.S. Cl. 292/336.3

(57) ABSTRACT

An automotive door having burglarproof structure adapted to prevent manipulation of lock assembly at locking apparatus even with the use of a tool through a gap between a door glass and a portion of outside handle, allowing only an exclusive car key to release the locking apparatus of door, the automotive door having burglarproof structure, wherein a locking apparatus comprises an actuator operated at a driver's seat by a switch and a lock assembly coupled via a rod assembly to outside/inside handles manipulated in and outside of an automobile, the lock assembly further including a lock lever for manipulating an actuating unit for locking and releasing operations and a fixation bracket for fixing the actuating unit and the lock lever to a run channel of a door, whereas the lock lever is integrally formed thereon with a slider of circular arch shape and the fixation bracket is integrally formed with a blocking plate protruded to block one side end of the lock lever.

### BACKGROUND OF THE INVENTION

1. Field of the Invention

The present invention relates to an automotive door having a burglarproof structure, and more particularly to an automotive door having a burglarproof structure adapted to prevent an unlawful door opening via a gap between a door glass and a door handle.

2. Description of the Prior Art

In general, a locking apparatus mounted at an automobile door includes, as illustrated in FIG. 1, an actuating unit 2 mechanically constructed to perform a locking and unlocking operation, a lock lever 3 for manipulating the actuating unit 2, a bracket 4 for coupling the actuating unit 2 and the lock lever 3 and for fixing same to a run channel of the door, a lock assembly 1 comprising the bracket 4 and connected to an actuator 5 operated by a switch connected to automatically open and close the door through a manipulating switch at dash board, and outside/inside handles 6 and 7 connected via various rod assemblies 8 for manually unlocking the door in and outside of an automobile.

The locking apparatus is generally equipped inside a panel comprising the door, such that, if the locking apparatus is to be released, the door cannot be opened unless a key appropriate for the locking apparatus is used.

However, there is a problem in the locking apparatus according to the prior art thus described in that a gap is inevitably created between a vertically-operated door glass (G) and a door panel, through which a rigid thin wire or a thin tool can be inserted therebetween into the door to press the lock lever 3 of the lock assembly 1, releasing the locked state of the locking apparatus.

There is another problem in that portion around the outside handle 6 mounted outside of the door can be partially destroyed, or a coupled portion of the handle can be utilized at a gap thereof, for a thin rigid wire or thin tool to be inserted thereinto for release of the locked state of locking apparatus by pressing the lock lever 3 of the lock assembly 1.

### SUMMARY OF THE INVENTION

The present invention is disclosed to solve the aforementioned problems and it is an object of the present invention to provide an automotive door having burglarproof structure adapted to prevent manipulation of lock assembly at locking apparatus even with the use of a tool through a gap between a door glass and a portion of outside handle, allowing only an exclusive car key to release the locking apparatus of door.

In accordance with the object of the present invention, there is provided an automotive door having burglarproof structure, wherein a locking apparatus comprises an actuator operated at a driver's seat by a switch and a lock assembly coupled via a rod assembly to outside/inside handles manipulated in and outside of an automobile, the lock assembly further including a lock lever for manipulating an actuating unit for locking and releasing operations and a fixation bracket for fixing the actuating unit and the lock lever to a run channel of a door, whereas the lock lever is integrally formed thereon with a slider of circular arch shape and the fixation bracket is integrally formed with a blocking plate protruded to block one side end of the lock lever.

### BRIEF DESCRIPTION OF THE DRAWINGS

For fuller understanding of the nature and objects of the invention, reference should be made to the following detailed description taken in conjunction with the accompanying drawings in which:

FIG. 1 is a constitutional drawing of a door mounted with a burglarproof structure according to the present invention;

FIG. 2 is a first constitutional drawing for illustrating a burglarproof operation utilizing a lock assembly according to the present invention; and

FIG. 3 is a second constitutional drawing for illustrating a burglarproof operation utilizing a lock assembly according to the present invention.

### DETAILED DESCRIPTION OF THE INVENTION

Preferred embodiments of the present invention will now be described in detail with reference to the accompanying drawings.

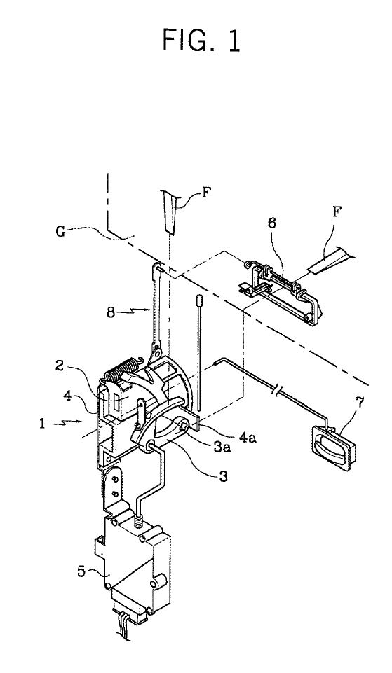

FIG. 1 is a constitutional drawing of a door mounted with a burglarproof structure according to the present invention. A locking apparatus according to the present invention includes a lock assembly 1 for manipulating a locking and releasing operation, an actuator 5 connected to the lock assembly 1 to open and close the lock assembly 1 according to switch manipulation at the driver seat, and outside/inside handles 6 and 7 connected via various rod assemblies 8 for manually releasing locked state of the door from inside and outside of the automobile.

At this time, the lock assembly 1 includes an actuating unit 2 mechanically coupled for locking and releasing operations, a lock lever 3 for manipulating the actuating unit 2 and a fixation bracket 4 for coupling the actuating unit and the locking lever 3 and fixing same to a run channel of a door, whereas the lock lever 3 is integrally formed thereon with a slider 3a of arch shape and the fixation bracket 4 is integrally formed with a blocking plate 4a protruded to block one side end of the lock lever 3.

Now, operation of the present invention will be described in detail.

First of all, when a thin wire or a thin tool (F) is inserted into a door utilizing a gap created between a door glass (G) and a door panel to place the wire or the tool at a site of the lock lever 3 of the lock assembly 1 at the lock apparatus, the tool (F) is positioned at the slider 3a formed above the lock lever 3, by which the tool (F) pressed downward is slipped to be prevented from manipulating the lock lever 3.

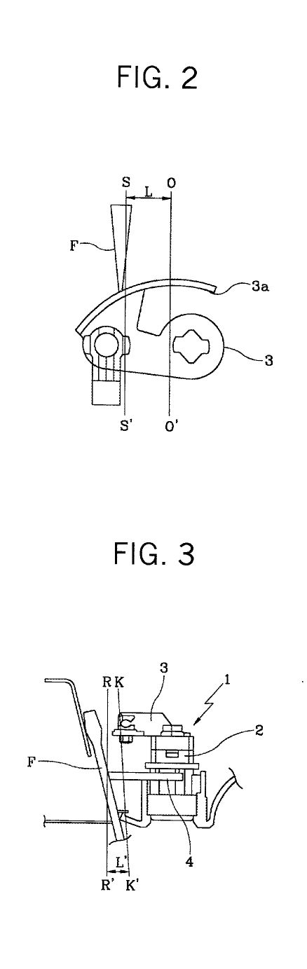

In other words, as illustrated in FIG. 2, inroad line (S-S′) of the tool (F) is deviantly positioned from a center line (O-O′) from which the lock lever 3 can be manipulated, such that pressing force of the tool (F) does not allow the lock lever 3 to be manipulated, slipping to an arrow direction which is external side of the center line (O-O′).

Meanwhile, even if site of the outside handle 6 mounted externally of the door is partially destroyed, or a gap at handle coupling area is utilized to enable a thin wire or thin tool (F) to be inserted into the door and to be positioned toward the lock lever 3 of the lock assembly 1, a blocking distance (L′) is formed by a blocking line (R-R′) of blocking plate 4a ahead of end line (K-K′) of the lock lever 3, such that the tool (F) is inserted into a position farther distanced from the lock lever 3 by the blocking plate 4a to prevent the lock lever 3 from being manipulated, as illustrated in FIG. 3.

As apparent from the foregoing, there is an advantage in the automotive door having burglarproof structure thus described according to the present invention in that a tool inserted into a gap between a door glass and portion of an outside handle cannot apply force to a lock lever at lock assembly functioning as lock/release operation, or approach thereof is blocked, thereby allowing only an exclusive car key to lock and unlock a door, such that release of a locking apparatus of the door can be fundamentally avoided to thereby prevent a car theft.

What is claimed is:

1. An automotive door having burglarproof structure, wherein a locking apparatus comprises an actuator operated at a driver's seat by a switch and a lock assembly coupled via a rod assembly to outside/inside handles manipulated in and outside of an automobile, the lock assembly further including a lock lever for manipulating an actuating unit for locking and releasing operations and a fixation bracket for fixing the actuating unit and the lock lever to a run channel of a door, whereas the lock lever is integrally formed thereon with a slider of circular arch shape and the fixation bracket is integrally formed with a blocking plate protruded to block one side end of the lock lever.

2. The door as defined in claim 1, wherein an apex of circular arch shape of the slider is distanced from a center line of external pressing force such that the lock lever cannot be manipulated by the external pressing force.
